(19) United States
(12) Patent Application Publication
(10) Pub. No.: US 2020/0055130 A1
(43) Pub. Date: Feb. 20, 2020

(54) Cutting Tool Head

(71) Applicant: Milwaukee Electric Tool Corporation, Brookfield, WI (US)

(72) Inventors: Marc S. D'Antuono, Whitefish Bay, WI (US); Ryan Murray, Cedar Falls, IA (US)

(21) Appl. No.: 16/532,818

(22) Filed: Aug. 6, 2019

Related U.S. Application Data
(60) Provisional application No. 62/718,800, filed on Aug. 14, 2018.

(51) Int. Cl. B23D 35/00; B23D 17/06

(52) U.S. Cl. CPC B23D 35/002; B23D 17/06; B23D 35/001

(57) ABSTRACT

A cutting head for a power tool. The cutting head comprises a pivot pin, and a first jaw and a second jaw each disposed for rotation about an axis defined by the pivot pin. The first jaw comprises a first blade mounting surface and a first ear having a first ear surface. The second jaw comprises a second blade mounting surface and a second ear having a second ear surface for rotational engagement with the first ear surface. The cutting head further comprises a first blade mounted on the first blade mounting surface and a second blade mounted on the second blade mounting surface. The first blade mounting surface, the second blade mounting surface, the first ear surface, and the second ear surface are substantially co-planar, and during a cutting action, the jaws rotate about the axis.

### FIELD

The present disclosure relates generally to power tools. More particularly, the present disclosure relates to a power tool having a cutting head of which mounting surfaces for blades or are co-planar with the ear surfaces.

### BACKGROUND

Hydraulic crimpers and cutters are different types of hydraulic power tools for performing work (e.g., crimping or cutting) on a workpiece. In such tools, a hydraulic tool comprising a hydraulic pump is utilized for pressurizing hydraulic fluid and transferring it to a cylinder in the tool. This cylinder causes an extendible piston to be displaced towards a cutting head. The piston exerts a force on the cutting head of the power tool, which may typically include opposed jaws with certain cutting features, depending upon the particular configuration of the power tool. In this case, the force exerted by the piston may be used for closing the jaws to perform cutting on a workpiece (e.g., a wire) at a targeted cutting location.

Certain hydraulic cutting tools (or other types of power tools) and associated cutting heads are known. For example, one known cutting tool head utilizes jaws that pivot about a pivoting point axis. Both jaws of such a cutting tool head may have a respective ear through which a pivot pin is placed so that the jaw(s) can pivot about the pivot pin. These ears may interlock, and one or both jaws may have a cutting blade of which a portion rests on that jaw's ear (e.g., mounted on or integral with the jaw's ear) so that, when the jaws are closed, the blades pass by each other. There are certain perceived disadvantages of utilizing a cutting tool head such as this, however. For example, when cutting certain workpieces, particular those that typically require more force to cut through, the jaws can jam before the workpiece is fully cut through. Further, a cutting action with this tool head can cause the jaws, and thus in turn the blades, to be forced apart. For example, the cutting force can push each blade against the surface to which the blade is mounted, which causes the blades/jaws to be pushed apart. This can occur when cutting thicker workpieces, or even when cutting thinner workpieces, such as individual strands (or groups) of flexible, fine-stranded wire (e.g., fine-stranded copper cable).

Therefore, there is a need for a cutting power tool that may be used to achieve a full, controllable cut while minimizing or eliminating the force that tends to push the blades apart during a cutting action.

### SUMMARY

According to a first exemplary embodiment, a cutting head for a power tool is disclosed. The cutting head comprises a pivot pin. The cutting head further comprises a first jaw disposed for rotation about an axis defined by the pivot pin. The first jaw comprises a first blade mounting surface and further comprises a first ear having a first ear surface, where the first ear has a first ear bore for receiving the pivot pin. The cutting head further comprises a second jaw disposed for rotation about the axis defined by the pivot pin. The second jaw comprises a second blade mounting surface and further comprises a second ear having a second ear surface for rotational engagement with the first ear surface, where the second ear has a second ear bore for receiving the pivot pin. The cutting head further comprises a first blade mounted on the first blade mounting surface of the first jaw. The cutting head further comprises a second blade mounted on the second blade mounting surface of the second jaw. The first blade mounting surface, the second blade mounting surface, the first ear surface, and the second ear surface are substantially co-planar. During a cutting action, the jaws rotate about the axis defined by the pivot pin.

According to a second exemplary arrangement, a power tool is disclosed. The power tool comprises the cutting head of the first exemplary embodiment. The power tool further comprises a moveable piston coupled to the cutting head. The power tool further comprises a motor operable to drive the moveable piston to open and close the first jaw and the second jaw. The power tool further comprises a controller configured to operate the motor.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of an illustrative embodiment of the present disclosure when read in conjunction with the accompanying drawings, wherein:

FIG. 1 illustrates a perspective view of a cutting head.

FIG. 2 illustrates an exploded view of the cutting head illustrated in FIG. 1.

FIG. 3 illustrates a perspective view of another embodiment of the cutting head illustrated in FIGS. 1 and 2.

FIG. 4 illustrates another perspective view of the cutting head illustrated in FIG. 3.

FIG. 5 illustrates yet another perspective view of the cutting head illustrated in FIG. 3.

FIG. 6 illustrates a perspective view of the cutting head with jaws closed.

FIG. 7 illustrates a simplified block diagram of a power tool according to an example embodiment.

### DETAILED DESCRIPTION

Disclosed embodiments will now be described more fully hereinafter with reference to the accompanying drawings, in which some, but not all of the disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art.

Embodiments herein are primarily described with respect to hydraulic power tools, but it should be understood that the disclosed working head arrangements could be included in other types of power tools as well.

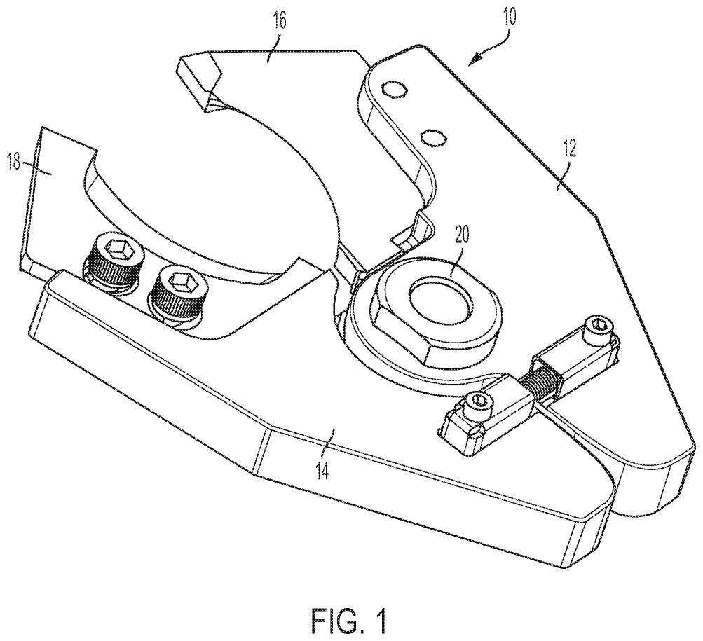

FIG. 1 illustrates a biased open cutting head 10 for a power tool. Although embodiments are primarily described herein as being biased open by way of one or more biasing members (e.g., springs), other embodiments of the cutting head 10 could be biased closed by way of one or more biasing members (e.g., springs).

The cutting head 10 comprises jaws including a first jaw 12 and a second jaw 14. The cutting head 10 further comprises a pair of blades. The pair of blades include a first blade 16 that is mounted on the first jaw 12 and a second blade 18 that is mounted on the second jaw 14. The pair of blades 16, 18 are removably mounted on the jaws 12, 14 so that the blades can be replaced, such as after repeated use. The cutting head 10 further comprises a pivot pin 20 that defines an axis about which the jaws 12, 14 rotate.

Although not shown in FIG. 1, the cutting head 10 can be part of a hydraulic power tool. In one embodiment, the hydraulic power tool can comprise an electric motor, a pump driven by the motor, and a housing defining a cylinder therein. An extendable piston can be disposed within the cylinder. The pump can provide pressurized hydraulic fluid to the piston cylinder, causing the piston to extend from the housing to thereby actuate the jaws 12, 14 of the cutting head 10 for cutting a workpiece, such as a wire. Other power sources can be used to power the tool. Once a workpiece or other target is placed between the jaws 12, 14, the hydraulic power tool can be powered to close the jaws 12, 14 to perform a cutting action and cut the workpiece or other target. Other types of power tools are possible as well.

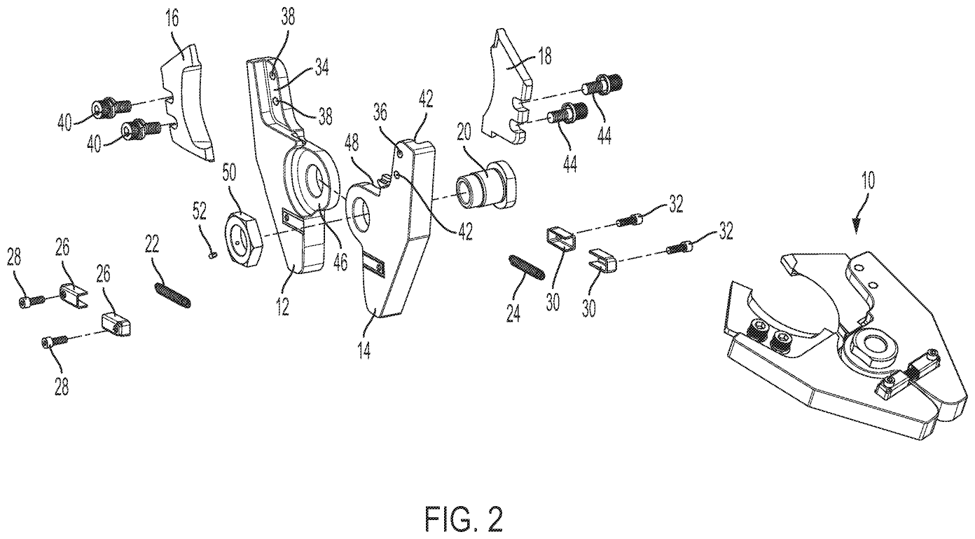

FIG. 2 illustrates an exploded view of the various components parts making up the cutting head 10 illustrated in FIG. 1. Shown again are the first jaw 12, the second jaw 14, the first blade 16, the second blade 18, and the pivot pin 20. When the jaws 12, 14 are assembled together, the pivot pin 20 defines an axis for the jaws 12, 14 about which the jaws 12, 14 rotate and enables rotational movement of the jaws 12, 14 about the axis, such as during a cutting action.

Further elements of the cutting head 10 can include one or more biasing members configured to bias the jaws 12, 14 toward open position. For example, as shown, the one or more biasing members are a pair of extension springs including a first extension spring 22 and a second extension spring 24, each configured to bias the jaws 12, 14 toward open position. When the component parts of the cutting head 10 are assembled to form the cutting head 10, the first extension spring 22 is on a first side of the cutting head 10 and the second extension spring 24 is on a second side of the cutting head 10, opposite the first side. The first extension spring 22 is retained by a first spring cover 26, and a first pair of spring mount screws 28 are inserted into screw bores in the first spring cover 26 to mount the first spring cover 26 (and in turn, the first extension spring 22) to the jaws 12, 14 on the first side of the cutting head 10. Likewise, the second extension spring 24 is retained by a second spring cover 30, and a second pair of spring mount screws 32 are inserted into screw bores in the second spring cover 30 to mount the second spring cover 30 (and in turn, the second extension spring 24) to the jaws 12, 14 on the second side of the cutting head 10. The first and second pairs of spring mount screws 28, 32 can alternatively be another type of screw, or a different type of fastener could be used to mount the spring covers 26, 30 to the jaws 12, 14.

In additional or alternative embodiments, the working head 10 can include one or more other types of biasing members (e.g., other types of springs or other types of biasing mechanisms) configured to bias the jaws 12, 14 of the working head 10 open or closed.

Each jaw has a respective blade mounting surface onto which to mount the blades 16, 18. In particular, the first jaw 12 has a first blade mounting surface 34 and the second jaw 14 has a second blade mounting surface 36. Each of the blade mounting surfaces 34, 36 is substantially planar.

To mount the blades 16, 18 on the jaws 12, 14, each jaw can also include a respective set of one or more bores configured to receive a respective set of one or more blade fasteners. For example, as shown, the first jaw 12 includes a first pair of screw bores 38 configured to receive a first pair of blade mount screws 40, and the second jaw 14 includes a second pair of screw bores 42 configured to receive a second pair of blade mount screws 44. Each pair of screw bores 38, 42 can be threaded so as to securely hold the pairs of blade mount screws 40, 44. In alternative examples, more or less than two bores can be included in each jaw. Further, in alternative examples, the blades 16, 18 can be mounted on the jaws 12, 14 using another type of fastener, such as bolts or pins. As such, the pair of bores can take other forms that are configured to receive such other types of fasteners.

Furthermore, in still other alternative examples, the blades 16, 18 and the jaws 12, 14 can comprise an integral component. For example, the first blade 16 can be crimped, welded, snap-fitted, or otherwise made to be integral with the first jaw 12 on the first blade mounting surface 34, and the second blade 18 can be crimped, welded, snap-fitted, or otherwise made to be integral with the second jaw 14 on the second blade mounting surface 36. Other examples are possible as well.

The blades 16, 18 each include a pair of notches on a side of the blade opposite the side of the blade's edge. The pair of notches are used for mounting the blades 16, 18 on the jaws 12, 14. In particular, to mount the first blade 16, the first blade 16 is positioned on the first blade mounting surface 34 and the first pair of blade mount screws 40 are inserted through the pair of notches in the first jaw 12, through the first pair of screw bores 38, and then tightened to secure the first blade 16 into place. Likewise, to mount the second blade 18, the second blade 18 is positioned on the second blade mounting surface 36 and the second pair of blade mount screws 44 are inserted through the pair of notches in the second jaw 14, through the first pair of screw bores 42, and then tightened to secure the second blade 18 into place. In alternative embodiments, each blade could include a pair of bores instead of a pair of notches. Further, in alternative embodiments, each blade can include more or less than two notches/bores. Still further, in embodiments where the blades 16, 18 are integral with the jaws 12, 14, the blades 16, 18 might not include any notches or bores.

As further illustrated in FIG. 2, the jaws 12, 14 each have ears for rotational engagement with each other. The jaw of each ear has a respective ear surface. In particular, the ear of jaw 12 has a first ear surface 46, and the ear of jaw 14 has a second ear surface 48. Each of the ear surfaces 46, 48 is substantially planar. In addition, each ear surface has a particular spatial relationship with the opposite jaw's blade, which provides various advantages, as will be described in more detail below. When the cutting head 10 is assembled, the two ear surfaces 46, 48 can contact each other and rotationally engage with each other.

Each ear has a bore respectively sized for receiving the pivot pin 20. In particular, the ear of jaw 12 has a first ear bore and the ear of jaw 14 has a second ear bore. As such, to bring the jaws 12, 14 together, the bores of the ears are aligned and the pivot pin 20 is inserted through the bores so that a head of the pivot pin 20 rests against one of the jaws 12, 14. For example, the pivot pin 20 could be inserted through the bores so that the head of the pivot pin 20 rests against the second jaw 14. A nut 50 can then be placed around the opposite end of the pivot pin 20 (e.g., the end closer to the first jaw 12) and a set screw 52 can be inserted into a bore of the nut 50 to hold the nut in place around the pivot pin 20. The nut 50 can include a groove for receiving an end of the set screw 52 when the set screw 52 is screwed into place. The nut 50 thus securely holds the jaws 12, 14 together. Other techniques could be used to securely assemble the jaws 12, 14 together, such as a press-fit (e.g., a press-fit ring), adhesive, jam nut (e.g., with a hollow bolt), or any other suitable technique. In some examples, the nut 50 can be a hex nut and the set screw can be a cone point set screw, although other types of nuts and set screws are possible as well.

The cutting head 10 comprises a plurality of substantially co-planar surfaces. In particular, the first blade mounting surface 34, the second blade mounting surface 36, the first ear surface 46, and the second ear surface 48 are substantially co-planar. Thus, in operation during a cutting action, the surface of the first ear that the second blade 18 will go past (e.g., the first ear surface 46) is on the same plane as the surface that the second blade 18 is mounted on (e.g., the second blade mounting surface 36). Likewise, the surface of the second ear that the first blade 16 will go past (e.g., the second ear surface 48) is on the same plane as the surface that the first blade is mounted on (e.g., the first blade mounting surface 34).

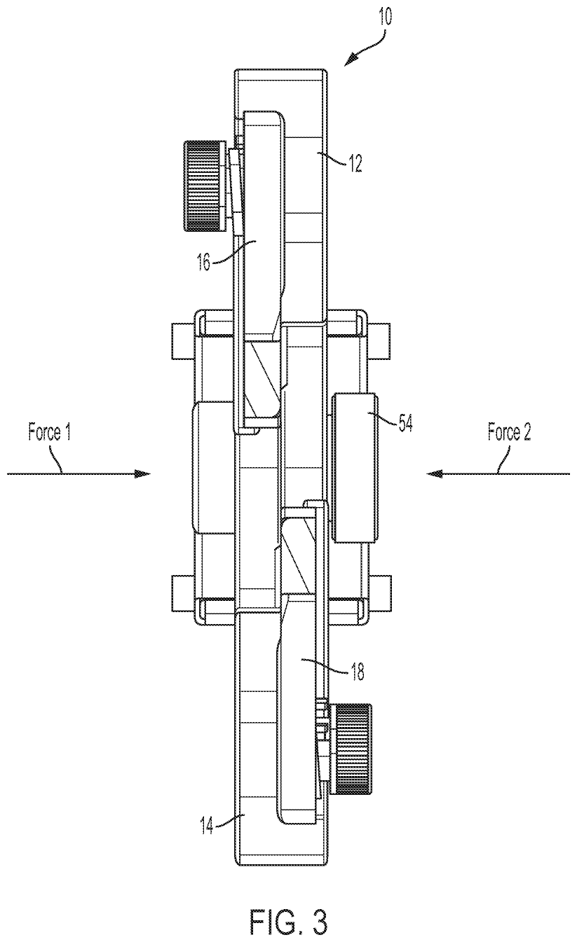

As so arranged, force applied in performing a cutting action pushes the blades 16, 18 (and jaws 12, 14) together, as opposed to being pushed away from each other (which would typically occur with conventional cutting heads). The direction of force that results during a cutting action is shown in FIG. 3.

FIG. 3 illustrates a perspective view of another embodiment of the cutting head 10 illustrated in FIGS. 1 and 2. In particular, absent from the embodiment of the cutting head 10 shown in FIG. 3 is a hex-shaped head of the pivot pin 20 shown in FIGS. 1 and 2 and the nut 50. Instead, the head of the pivot pin 20 is circular and a press-fit ring 54 is securely fitted around a circumference of the pivot pin 20 at the other end of the pivot pin 20. Thus, the jaws 12, 14 are held together.

During a cutting action, rather than the blades 16, 18 and jaws 12, 14 being pushed apart, the first blade 16 is pushed against the first jaw 12 (i.e., against blade mounting surface 34 shown in FIG. 2) in a first direction of force, labelled as “Force 1” in FIG. 3. And the second blade 18 is pushed against the second jaw 14 (i.e., against blade mounting surface 36 shown in FIG. 2) in a second direction of force, labelled as “Force 2” in FIG. 3. The ear surfaces 46, 48 are pushed against each other as well. Again. by having the blade mounting surfaces 34, 36 and the ear surfaces 46, 48 substantially co-planar, the cutting head 10 can improve the cutting action of workpieces, such as fine-stranded copper wire.

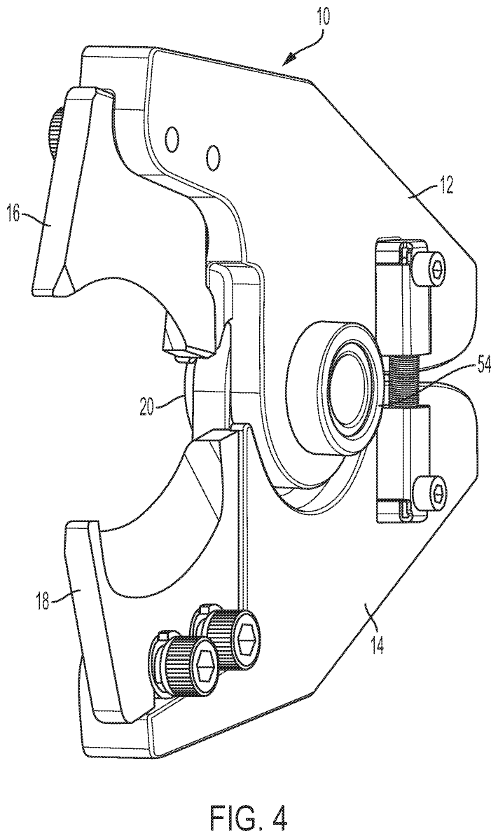

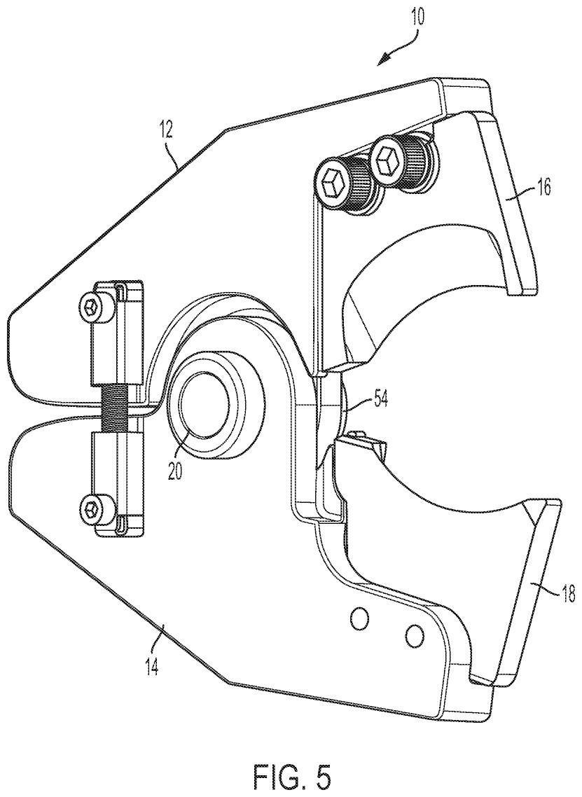

FIG. 4 illustrates another perspective view of the cutting head 10 illustrated in FIG. 3. And FIG. 5 illustrates yet another perspective view of the cutting head 10 illustrated in FIG. 3.

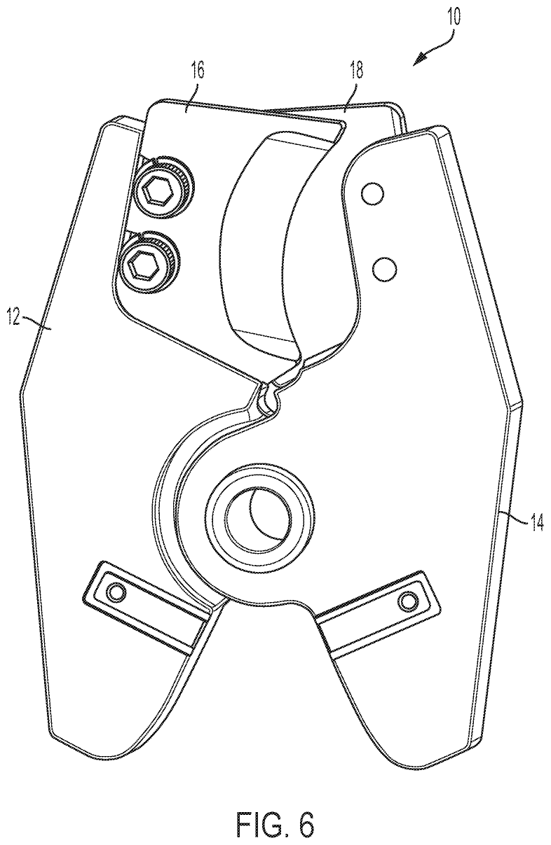

FIG. 6 illustrates a perspective view of the cutting head 10 with the jaws 12, 14 in a closed position. Absent from the embodiment of the cutting head 10 shown in FIG. 5 is a pivot pin and extension springs. Due to the co-planarity of the blade mounting surfaces 34, 36 and the ear surfaces 46, 48, the blades 16, 18 are in close proximity in a closed position—namely, such that a portion of a surface of the first blade 16 that is mounted on the first blade mounting surface 34 may contact a portion of a surface of the second blade 18 that is mounted on the second blade mounting surface 36. As a result of keeping the blades 16, 18 in close contact, the cutting head 10 could improve the way certain workpieces are cut, such as fine-stranded copper wire.

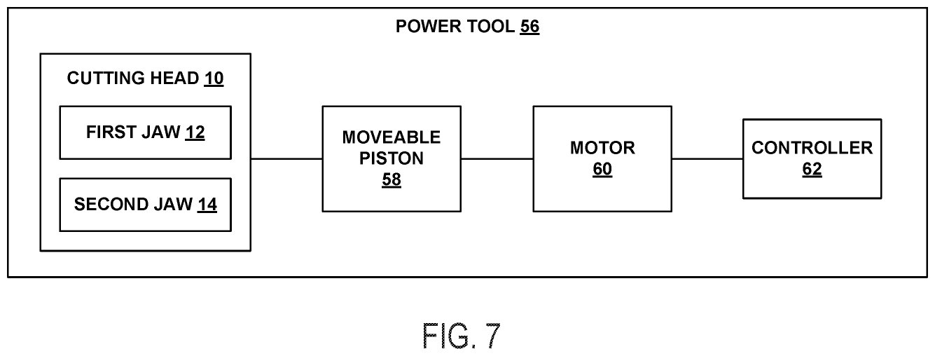

Finally, FIG. 7 illustrates a simplified block diagram of an example of a power tool 56 that can include the cutting head 10 described above. In addition to the cutting head 10, the power tool 56 includes a moveable piston 58 coupled to the cutting head 10, a motor 60 operable to drive the moveable piston 58 to open and close the jaws 12, 14, and a controller 62 configured to operate the motor 60. The power tool 56 can include and/or omit any of the components described above.

Although not shown, the power tool 56 can, in some embodiments, include a position sensor for indicating to the controller 62 that the jaws 12, 14 are in the open or closed position, so that the controller 62 can determine when the jaws 12, 14 are in the open position and when the jaws 12, 14 are in the closed position, and thereby determine when to start or stop operation of the motor 60. Once the controller 62 determines that the jaws 12, 14 are in the closed position, for instance, the controller 62 can stop operation of the motor 60.

In some embodiments, the power tool 56 can take the form of a hydraulic power tool, in which case the power tool 56 can include additional components not shown in FIG. 7, such as a gear reducer, a pump, a fluid reservoir, and/or a pressure sensor.

Within examples, the jaws 12, 14 of the power tool 56 can open and close to perform work on a workpiece such as cutting the workpiece, as described above. More specifically, the motor 60 can drive the moveable piston 58 to move at least one of the jaws 12, 14 towards another of the jaws 12, 14 until the jaws 12, 14 reach a closed position. The motor 60 can also drive the moveable piston 58 to move at least one of the jaws 12, 14 away from another of the jaws 12, 14 until the jaws 12, 14 reach an open position.

The presently disclosed cutting head provides a number of advantages over known power tools. For example, one advantage of the presently known power tool is that force applied during a cutting action—particularly, large amounts of force—causes the blades and jaws to be pushed toward each other as opposed to being pushed apart. This can help achieve a full cut of a workpiece or other target without causing the jaws to jam. Another advantage is that, by having the cutting head arranged such that the blade mounting surfaces are co-planar with the ear surfaces, all such surfaces can be computer numerical control (CNC) machined in the same setup with precise tolerances to achieve co-planarity.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

By the term “substantially” or “about” used herein, it is meant that the recited characteristic, parameter, value, or geometric planarity need not be achieved exactly, but that deviations or variations, including for example, tolerances, measurement error, measurement accuracy limitations and other factors known to skill in the art, may occur in amounts that do not preclude the effect the characteristic was intended to provide.

We claim:

1. A cutting head for a power tool, the cutting head comprising:
a pivot pin;
a first jaw disposed for rotation about an axis defined by the pivot pin, the first jaw comprising a first blade mounting surface and further comprising a first ear having a first ear surface, wherein the first ear has a first ear bore for receiving the pivot pin;
a second jaw disposed for rotation about the axis defined by the pivot pin, the second jaw comprising a second blade mounting surface and further comprising a second ear having a second ear surface for rotational engagement with the first ear surface, wherein the second ear has a second ear bore for receiving the pivot pin;
a first blade mounted on the first blade mounting surface of the first jaw; and
a second blade mounted on the second blade mounting surface of the second jaw,
wherein the first blade mounting surface, the second blade mounting surface, the first ear surface, and the second ear surface are substantially co-planar, and
wherein during a cutting action, the jaws rotate about the axis defined by the pivot pin.

2. The cutting head of claim 1, wherein the first blade mounting surface includes a first set of one or more bores configured to receive a first set of one or more fasteners,
wherein the second blade mounting surface includes a second set of one or more bores configured to receive a second set of one or more fasteners,
wherein the first blade is mounted on the first blade mounting surface by the first set of one or more fasteners, and
wherein the second blade is mounted on the second blade mounting surface by the second set of one or more fasteners.

3. The cutting head of claim 2, wherein the first set of one or more fasteners is a first pair of blade mount screws, and
wherein the second set of one or more fasteners is a second pair of blade mount screws.

4. The cutting head of claim 3, wherein the first blade includes a first pair of notches or a first pair of bores through which the first pair of blade mount screws are inserted to mount the first blade on the first blade mounting surface, and
wherein the second blade includes a second pair of notches or a second pair of bores through which the second pair of blade mount screws are inserted to mount the second blade on the second blade mounting surface.

5. The cutting head of claim 1, wherein the first blade is mounted on the first blade mounting surface such that the first blade and the first jaw comprise an integral component.

6. The cutting head of claim 5, wherein the second blade is mounted on the second blade mounting surface such that the second blade and the second jaw comprise an integral component.

7. The cutting head of claim 1, further comprising:
one or more biasing members configured to bias the first jaw and the second jaw open.

8. The cutting head of claim 7, wherein the one or more biasing members are a pair of extension springs.

9. The cutting head of claim 1, further comprising:
one or more biasing members configured to bias the first jaw and the second jaw closed.

10. The cutting head of claim 1, wherein during the cutting action, the first blade passes the second ear surface, the second blade passes the first ear surface, and the ear surfaces push against each other.

11. A power tool comprising:
a cutting head comprising:
a pivot pin,
a first jaw disposed for rotation about an axis defined by the pivot pin, the first jaw comprising a first blade mounting surface and further comprising a first ear having a first ear surface, wherein the first ear has a first ear bore for receiving the pivot pin,
a second jaw disposed for rotation about the axis defined by the pivot pin, the second jaw comprising a second blade mounting surface and further comprising a second ear having a second ear surface for rotational engagement with the first ear surface, wherein the second ear has a second ear bore for receiving the pivot pin,
a first blade mounted on the first blade mounting surface of the first jaw, and
a second blade mounted on the second blade mounting surface of the second jaw;
a moveable piston coupled to the cutting head;
a motor operable to drive the moveable piston to open and close the first jaw and the second jaw; and
a controller configured to operate the motor,
wherein the first blade mounting surface, the second blade mounting surface, the first ear surface, and the second ear surface are substantially co-planar, and
wherein during a cutting action, the jaws rotate about the axis defined by the pivot pin.

12. The power tool of claim 11, wherein the power tool is a hydraulic cutting tool.

13. The power tool of claim 11, wherein the first blade mounting surface includes a first set of one or more bores configured to receive a first set of one or more fasteners,
wherein the second blade mounting surface includes a second set of one or more bores configured to receive a second set of one or more fasteners,
wherein the first blade is mounted on the first blade mounting surface by the first set of one or more fasteners, and
wherein the second blade is mounted on the second blade mounting surface by the second set of one or more fasteners.

14. The power tool of claim 13, wherein the first set of one or more fasteners is a first pair of blade mount screws, and
wherein the second set of one or more fasteners is a second pair of blade mount screws.

15. The power tool of claim 14, wherein the first blade includes a first pair of notches or a first pair of bores through which the first pair of blade mount screws are inserted to mount the first blade on the first blade mounting surface, and
wherein the second blade includes a second pair of notches or a second pair of bores through which the second pair of blade mount screws are inserted to mount the second blade on the second blade mounting surface.

16. The power tool of claim 11, wherein the first blade is mounted on the first blade mounting surface such that the first blade and the first jaw comprise an integral component.

17. The power tool of claim 16, wherein the second blade is mounted on the second blade mounting surface such that the second blade and the second jaw comprise an integral component.

18. The power tool of claim 11, further comprising:
one or more biasing members configured to bias the first jaw and the second jaw open.

19. The power tool of claim 11, further comprising:
one or more biasing members configured to bias the first jaw and the second jaw closed.

20. The power tool of claim 11, wherein during the cutting action, the first blade passes the second ear surface, the second blade passes the first ear surface, and the ear surfaces push against each other.
